(19) United States
(12) Patent Application Publication
(10) Pub. No.: US 2026/0045062 A1
(43) Pub. Date: Feb. 12, 2026

(54) CAMERA MONITOR SYSTEM WITH IDENTIFICATION OF EXCLUSION ZONE BASED ON OPTICAL FLOW ANALYSIS

(71) Applicant: Stoneridge Electronics AB, Solna (SE)

(72) Inventors: Saif Imran, Canton, MI (US); Kade Jones, Utrecht (NL); Liang Ma, Rochester, MI (US); Mohammad Gudarzi, Wixom, MI (US)

(21) Appl. No.: 18/800,363

(22) Filed: Aug. 12, 2024

(51) Int. Cl. G06V 10/26; E02F 9/24; E02F 9/26; G06T 7/20; G06V 20/58

(52) U.S. Cl. CPC G06V 10/26; E02F 9/24; E02F 9/261; G06T 7/20; G06V 20/58; G06T 2207/30252

(57) ABSTRACT

A method for a camera monitor system (CMS) includes utilizing a camera mounted to an ego machine to record images of a region exterior to the ego machine while the ego machine is in motion; performing an optical flow analysis to identify an image area in the images in which a portion of the ego machine appears; identifying an exclusion zone relative to the ego machine that corresponds to the identified image area; performing object detection for the images to detect an object; providing an object detection notification to an occupant of the ego machine based on the detected object meeting one or more notification criteria; and excluding the exclusion zone from said providing an object detection notification, such that object detection notifications are not provided for objects in the exclusion zone. A camera monitor system (CMS) is also disclosed.

### TECHNICAL FIELD

This disclosure relates to a camera monitor system (CMS), and more particularly to identification, based on an optical flow analysis, of an exclusion zone in relation to object detection notifications and/or the performance object detection.

### BACKGROUND

Vehicle camera systems for mirror replacement or for supplementing mirror views are utilized in commercial vehicles to enhance the ability of a vehicle operator to see a surrounding environment of the commercial vehicle. These systems are known as “camera monitor systems” (CMS), and they utilize one or more cameras to provide an enhanced field of view to a vehicle operator. CMS may also include cameras in locations not typically associated with a mirror, such as a rear camera (e.g., a trailer camera) that records images of an area behind a vehicle, a camera that records an area in front of a vehicle, etc.

The term “ego machine” refers to a machine that contains sensors that perceive the environment around the machine. As used herein, the term “ego machine” refers to a self-propelled vehicle which has tires or some other feature for self-propelled movement on land (e.g., a tank-style track that is advanced with rollers to provide motion of the machine). The ego machine may have a primary purpose of transportation (e.g., a commercial motor vehicle with tires), may have some other primary purpose, such as earth moving (e.g., a dozer, excavator, etc.).

In some ego machines, such as earth-moving machines, an operator may have a limited field of view with respect to the environment in which the ego machine is operating. The field of view may be limited by a movable tool, such as ripper, shovel, or scoop, that obstructs a vehicle operator's view of an environment surrounding the ego machine.

### SUMMARY

A method for a camera monitor system (CMS) according to an example embodiment of the present disclosure includes utilizing a camera mounted to an ego machine to record images of a region exterior to the ego machine while the ego machine is in motion; performing an optical flow analysis to identify an image area in the images in which a portion of the ego machine appears; identifying an exclusion zone relative to the ego machine that corresponds to the identified image area; performing object detection for the images to detect an object; providing an object detection notification to an occupant of the ego machine based on the detected object meeting one or more notification criteria; and excluding the exclusion zone from said providing an object detection notification, such that object detection notifications are not provided for objects in the exclusion zone.

In a further embodiment of the foregoing embodiment, the method includes excluding the exclusion zone from said performing object detection for the images, such that object detection is not performed in the exclusion zone.

In a further embodiment of any of the foregoing embodiments, said performing an optical flow analysis includes using a Lucas-Kanade algorithm.

In a further embodiment of any of the foregoing embodiments, the exclusion zone is a two-dimensional area of the images.

In a further embodiment of any of the foregoing embodiments, the exclusion zone is a three-dimensional space depicted in the images.

In a further embodiment of any of the foregoing embodiments, the region is at least partially in front of a cabin of the ego machine.

In a further embodiment of any of the foregoing embodiments, the region is at least partially behind a cabin of the ego machine.

In a further embodiment of any of the foregoing embodiments, the ego machine is an earth-moving machine.

In a further embodiment of any of the foregoing embodiments, the portion of the ego machine is movable relative to a cabin of the ego machine, and the portion of the ego machine includes at least one of a shovel, scoop, a claw, a ripper, a roller, or a movable arm.

In a further embodiment of any of the foregoing embodiments, the method includes storing the exclusion zone in non-volatile memory and, after a shut down and subsequent startup of the ego machine, utilizing the exclusion zone stored in the non-volatile memory for the excluding step.

A camera monitor system (CMS) according to an example embodiment of the present disclosure includes a camera mounted to an ego machine, the camera configured to obtain images of a region exterior to the ego machine. The CMS also includes processing circuitry operatively connected to memory. The processing circuitry is configured to utilize a camera mounted to an ego machine to record images of a region exterior to the ego machine while the ego machine is in motion; perform an optical flow analysis to identify an image area in the images in which a portion of the ego machine appears; identify an exclusion zone relative to the ego machine that corresponds to the identified image area; perform object detection for the images to detect an object; provide an object detection notification to an occupant of the ego machine based on the detected object meeting one or more notification criteria; and exclude the exclusion zone from the providing of the object detection notification, such that object detection notifications are not provided for objects in the exclusion zone.

In a further embodiment of the foregoing embodiment, the processing circuitry is configured to exclude the exclusion zone from the performance of object detection for the images, such that object detection is not performed in the exclusion zone.

In a further embodiment of any of the foregoing embodiments, the processing circuitry is configured to use a Lucas-Kanada algorithm to perform the optical flow analysis.

In a further embodiment of any of the foregoing embodiments, the exclusion zone is a two-dimensional area of the images.

In a further embodiment of any of the foregoing embodiments, the exclusion zone is a three-dimensional space depicted in the images.

In a further embodiment of any of the foregoing embodiments, the region is at least partially in front of a cabin of the ego machine.

In a further embodiment of any of the foregoing embodiments, the region is at least partially behind a cabin of the ego machine.

In a further embodiment of any of the foregoing embodiments, the ego machine is an earth-moving machine.

In a further embodiment of any of the foregoing embodiments, the portion of the ego machine is movable relative to a cabin of the ego machine, and the portion of the ego machine includes at least one of a shovel, scoop, a claw, a ripper, a roller, or a movable arm.

In a further embodiment of any of the foregoing embodiments, the memory includes non-volatile memory, and the processing circuitry is configured to store the exclusion zone in non-volatile memory and, after a shut down and subsequent startup of the ego machine, utilize the exclusion zone stored in the non-volatile memory for performance of the excluding of the exclusion zone.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE DRAWINGS

The disclosure can be further understood by reference to the following detailed description when considered in connection with the accompanying drawings wherein:

FIG. 1 is a schematic front view of a commercial vehicle with a camera monitor system (CMS) used to provide at least Class II and Class IV views.

FIG. 2 is a schematic birds-eye view of the commercial vehicle of FIG. 1 with a CMS providing Class II, Class IV, Class V, and Class VI views.

FIG. 3 is a schematic top view of an example vehicle cabin interior.

FIG. 4 is a perspective view of the vehicle cabin interior of FIG. 3.

FIG. 5 is a schematic side view of an earth-moving machine.

FIG. 6 is a schematic birds-eye view of the earth-moving machine of FIG. 5.

FIG. 7 is a perspective view of a cabin interior of the earth-moving machine of FIG. 5.

FIG. 8 is a schematic view of a CMS for the earth-moving machine of FIG. 5.

FIG. 9 is a schematic view of an example image from a camera of FIG. 2.

FIG. 10 is a schematic view of an example image from a camera of FIG. 5.

FIG. 11 is a flowchart of an example method for a CMS.

### DETAILED DESCRIPTION

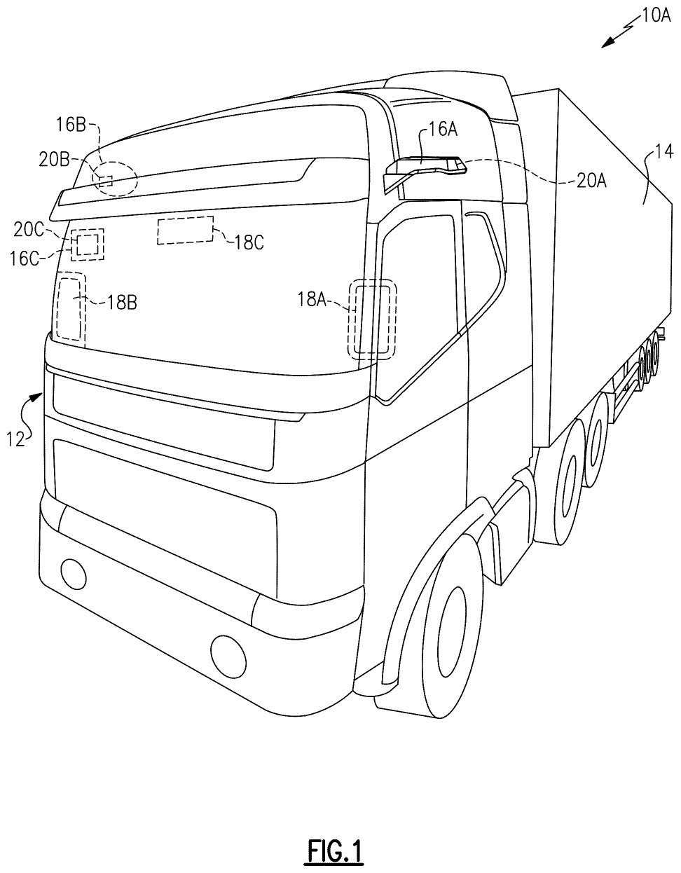

Schematic views of a commercial vehicle 10A (which is a type of ego machine) are illustrated in FIGS. 1-4. Although reference numeral 10A refers to the commercial vehicle depicted in FIGS. 1-4, reference numeral 10 will be generically used to refer to ego machines herein. The commercial vehicle 10A includes a vehicle cab or “tractor” 12 for pulling a trailer 14, where the trailer 14 pivots with respect to the tractor 12 during turns. Although the commercial vehicle 10A is depicted as a commercial truck with a single trailer in this disclosure, it is understood that other commercial vehicle configurations may be used (e.g., different types or quantities of trailers).

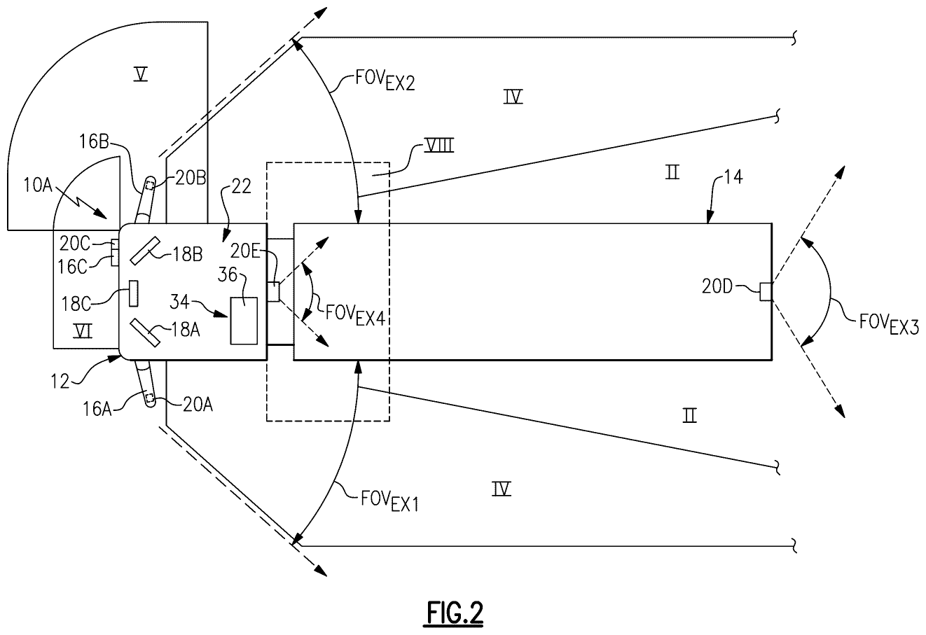

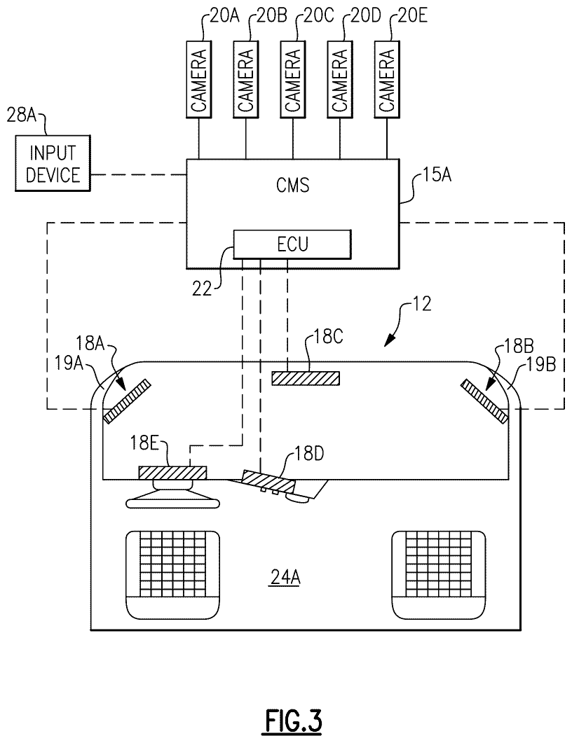

A pair of camera arms 16A-B include a respective base that is secured to, for example, the tractor 12. A pivoting arm is supported by the base and may articulate relative thereto. At least one rearward facing camera 20A-B is arranged respectively on or within the camera arms 16A-B. The cameras 20A-B are “rearward facing” in that they face towards a rear of the commercial vehicle 10A. The exterior cameras 20A-B respectively provide exterior fields of view FOV_{EX1}, FOV_{EX2} that each include at least one of Class II and Class IV views (FIG. 2), which are legally prescribed views in the commercial trucking industry. The cameras 20A-B are part of a camera monitor system (CMS) 15A (see FIG. 3).

The Class II view on a given side of the commercial vehicle 10A is a subset of the class IV view of the same side of the commercial vehicle 10A. Multiple cameras also may be used in each camera arm 16A-B to provide these views, if desired, or a single camera could be used in each camera arm 16A-B to provide the views. Class II (narrow) and Class IV (wide angle) views are defined in European R46 legislation, for example, and the United States and other countries have similar drive visibility requirements for commercial trucks. Any reference to a “Class” view is not intended to be limiting, but rather is intended as an example of the type of view provided to a display from a particular camera.

Each camera arm 16A-16B may also provide a housing that encloses electronics, e.g., a controller, that are configured to provide various features of the CMS 15A. The camera arms 16A-B may be mounted either at a roof-mount location over the cab door (as shown), or on a door-mounted bracket or station, for example.

If video of Class V and/or Class VI views is also desired, a camera housing 16C and camera 20C may be arranged at or near the front of the commercial vehicle 10A to provide those views (FIG. 2).

A backup camera 20D provides a field of view FOV_{EX3} of a rear area behind the commercial vehicle 10A, which overlaps the fields of view FOV_{EX1}, FOV_{EX2}. The backup camera 20D may be mounted at a top/centerline of the trailer, at a bumper/bed level of the trailer, or at a top-corner of the back of the trailer, for example.

Alternatively, or in addition to the rear trailer camera, a “fifth wheel camera” 20E may be provided that is mounted to a rear of the tractor 12 and that provides a field of view FOV_{EX4} which, when the trailer 14 is disconnected from the cab 12, also overlaps the fields of view FOV_{EX1}, FOV_{EX2}. The fifth wheel camera 20E may be mounted anywhere between the lateral plane of the fifth wheel fixture and the top/roof edge of the tractor, for example.

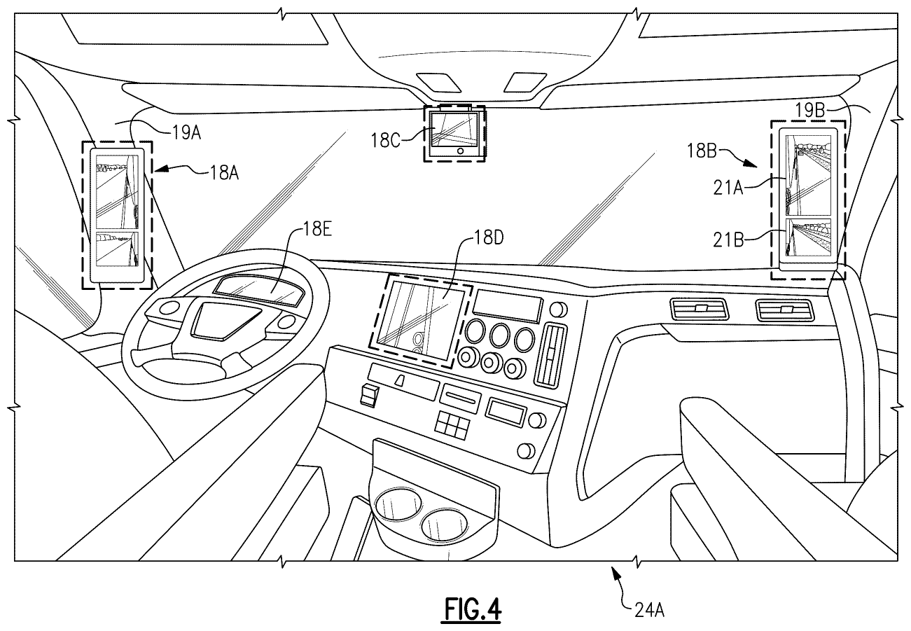

FIG. 3 is a schematic top view of an example interior of a vehicle cabin 24A, and FIG. 4 is a perspective view of the interior of the vehicle cabin 24A. Referring now to FIGS. 3-4 with continued reference to FIGS. 1-2, electronic displays 18A-E (e.g., which may be video displays, such as LCD displays) and cameras 20A-E are shown. The various electronic displays 18A-E and cameras 20A-E are part of the CMS 15A, and therefore act as CMS displays and CMS cameras. As used herein, a “CMS camera” 20 is a camera configured to record images of an environment surrounding ego machine 10, and a “CMS display” 18 is an electronic display (e.g., an LCD) that is configured to display image feeds from those cameras.

The CMS 15A includes a CMS electronic control unit (ECU) 22A that acts as a controller and includes processing circuitry that supports operation of the CMS 15A. The CMS ECU 22A is operatively connected to memory (which may include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). The processing circuitry may include one or more microprocessors, microcontrollers, application specific integrated circuits (ASICs), or the like.

The CMS displays 18A-B are arranged on each of the driver and passenger sides within the vehicle cab 12 on or near the A-pillars 19A-B to display Class II and Class IV views on its respective side of the commercial vehicle 10A, which provide rearward facing side views along the commercial vehicle 10A that are captured by the exterior cameras 20A-B. An input device 28A (e.g., keyboard, mouse scanner, touch interface, etc.) may be used by a vehicle operator to customize and/or control the CMS 15A.

As discussed above, if video of Class V and Class VI views is also desired, the camera housing 16C and camera 20C may be arranged at or near the front of the commercial vehicle 10A to provide those views (FIG. 2). In the example of FIG. 3, additional displays 18C-E are provided. Display 18C is arranged in the vehicle cabin 24A near the top center of the windshield may be used to display the Class V and Class VI views, which are toward the front of the commercial vehicle 10A, or a backup camera view (from camera 20D or 20E) to the driver, for example. Display 18D is provided in a center console area of the vehicle cabin 24A, and may be used as a backup display or for other purposes, such as navigation, infotainment, etc. Display 18E may be part of an instrument cluster, for example, and may be used as a backup display.

If desired, the camera arms 16A-B may include conventional mirrors integrated with them as well, although the CMS 15A may be used to entirely replace mirrors. In additional examples, each side can include multiple camera arms, with each arm housing one or more cameras and/or mirrors.

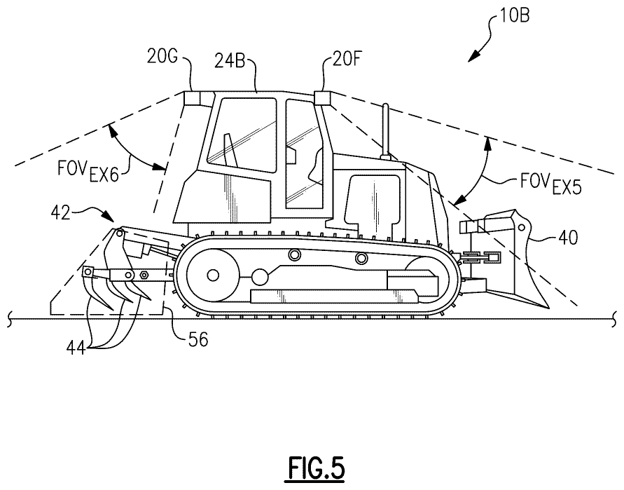

FIG. 5 is a schematic side view of an ego machine 10B that is an earth-moving machine, and in particular a dozer having a dozer blade 40 and also a ripper attachment 42 that includes a plurality of ripper teeth 44. Although a dozer is depicted in FIG. 5, it is understood that other ego machines could be used, such as other types of earth-moving machines (e.g., mining shovels, excavators, etc.).

The dozer 10B includes a cabin 24B, a front CMS camera 20F, and a rear CMS camera 20G. The front camera 20F provides a field of view FOV_{EX5} of an area in front of the dozer 10B, and the rear camera 20G provides a field of view FOV_{EX6} of an area behind the dozer 10B. Although only cameras 20F-G are depicted in FIG. 5, it is understood that additional or alternative cameras could be included (e.g., having fields of view that include areas adjacent to opposing sides of the vehicle). The cameras 20F-G may be mounted to a roof of the cabin 24B of the commercial vehicle 10, for example (e.g., through a mounting bracket).

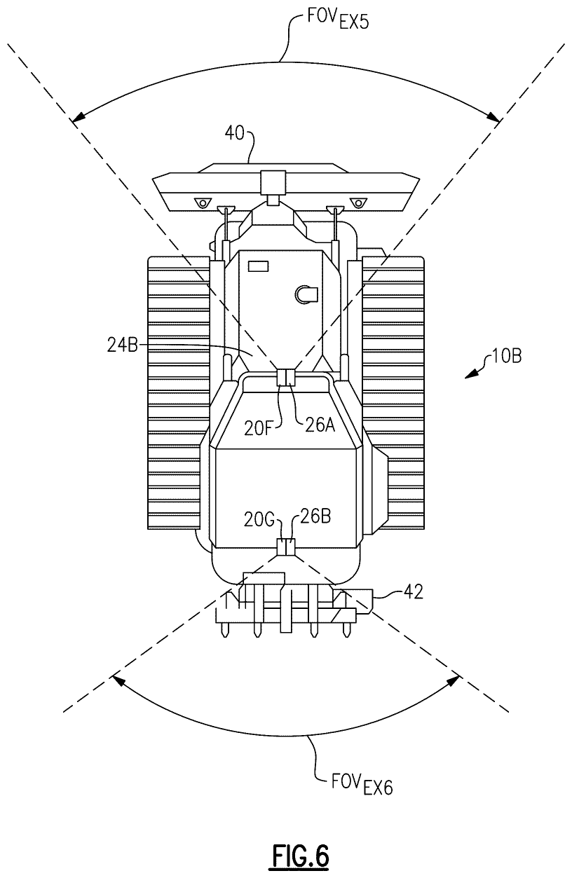

FIG. 6 is a schematic birds-eye view of the dozer 10B of FIG. 5. The fields of view FOV_{EX5} and FOV_{EX6} are depicted. As shown in FIG. 6, object detection sensors 26A-B may also be included. These are different than the cameras 20F-G, and may be LIDAR, RADAR, and/or ultrasonic sensors, for example. The object detection sensors 26A-B may be configured as companions (e.g., be located adjacent to and/or share a common housing with) the respective cameras 20F-G for performing object detection. Although not shown in FIGS. 1-4, it is understood that object detection sensors 26 may be provided for the commercial vehicle 10A as well.

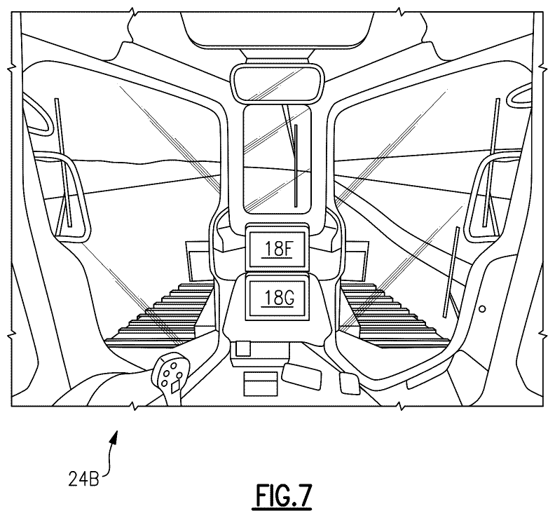

FIG. 7 is a perspective view of an interior of the cabin 24B of the dozer 10B, and depicts two example electronic displays 18F and 18G (e.g., LCD displays). In one or more embodiments, display 18F provides a video feed from camera 20F, and display 18G provides a video feed from camera 20G. Of course, it is understood that other quantities of displays could be used.

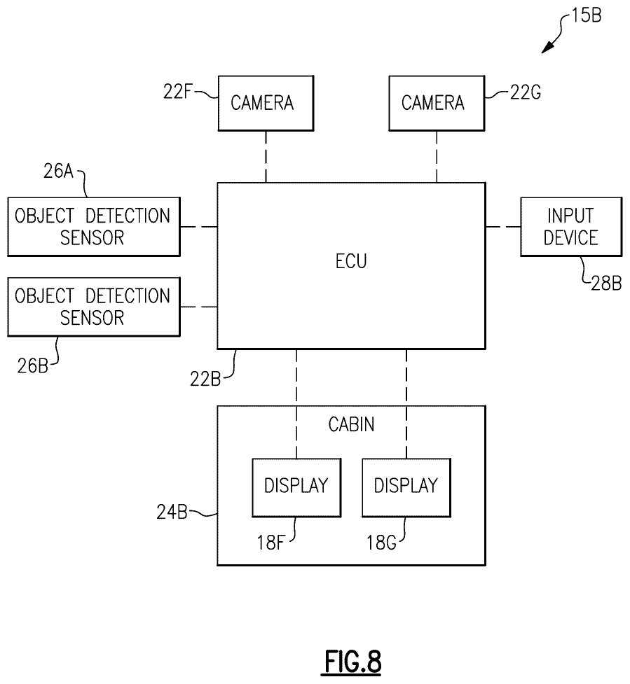

FIG. 8 is a schematic view of a CMS 15B for the earth-moving machine of FIG. 5. The CMS 15B includes an ECU 22B that acts as a controller and includes processing circuitry that supports operation of the CMS 15B. The CMS ECU 22B is operatively connected to memory (which may include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). The processing circuitry may include one or more microprocessors, microcontrollers, application specific integrated circuits (ASICs), or the like. Reference numeral 15 will generically be used to refer to a CMS herein, and reference numeral 22 will generically be used to refer to an ECU herein.

The ECU 22B is also operatively connected to the cameras 22F-G, to displays 18F-G in vehicle cabin 24B, and to object detection sensors 26A-B. The object detection sensors 26A-B may include LIDAR, RADAR, and/or ultrasonic sensors, for example. An input device 28B (e.g., keyboard, mouse scanner, touch interface, etc.) may be used by the operator to customize and/or control the CMS 15B.

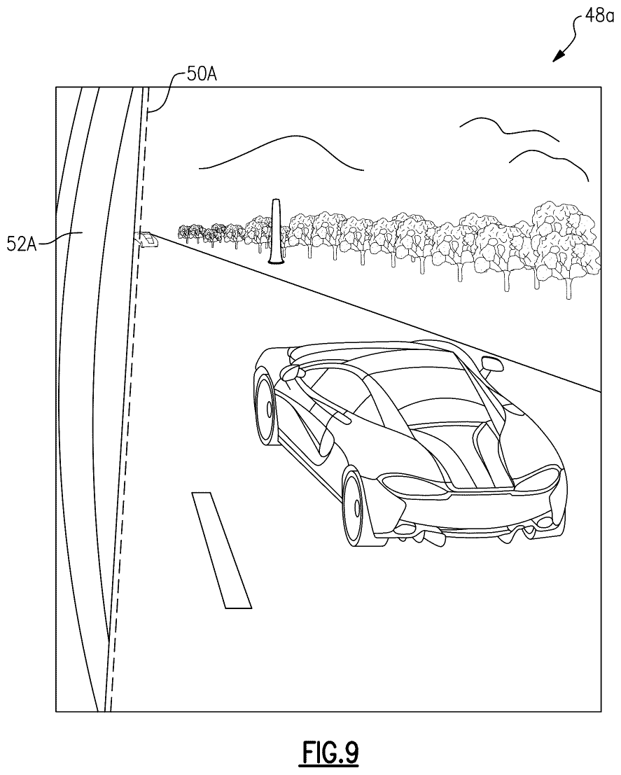

FIG. 9 is a schematic view of an example image 48A corresponding to camera 20B and field of view FOV_{EX2}. As shown, the image 48A depicts a region outside of the vehicle 10A corresponding to FOV_{EX2}, and includes an image area 50A in which a portion 52A of the trailer 14 of vehicle 10A appears at least intermittently.

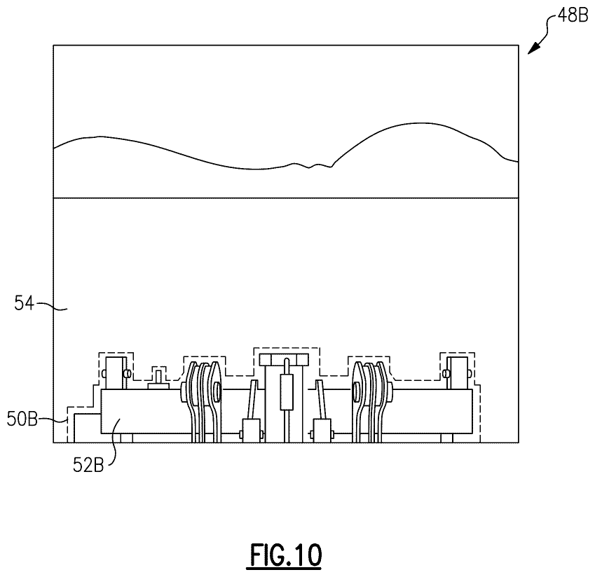

FIG. 10 is an example schematic image 48B corresponding to camera 20G and field of view FOV_{EX6}. As shown, the image 48B depicts a region outside of the vehicle 10B corresponding to FOV_{EX6}, and includes an image area 50B in which a portion 52B of the vehicle 10B appears at least intermittently. In the example of FIG. 10, the portion 52 corresponds to the ripper 42. As the ripper 42 is utilized (e.g., extended and/or retracted, lifted and/or lowered, etc.), the size of the image area 50B in which the ripper 42 appears may increase or decrease.

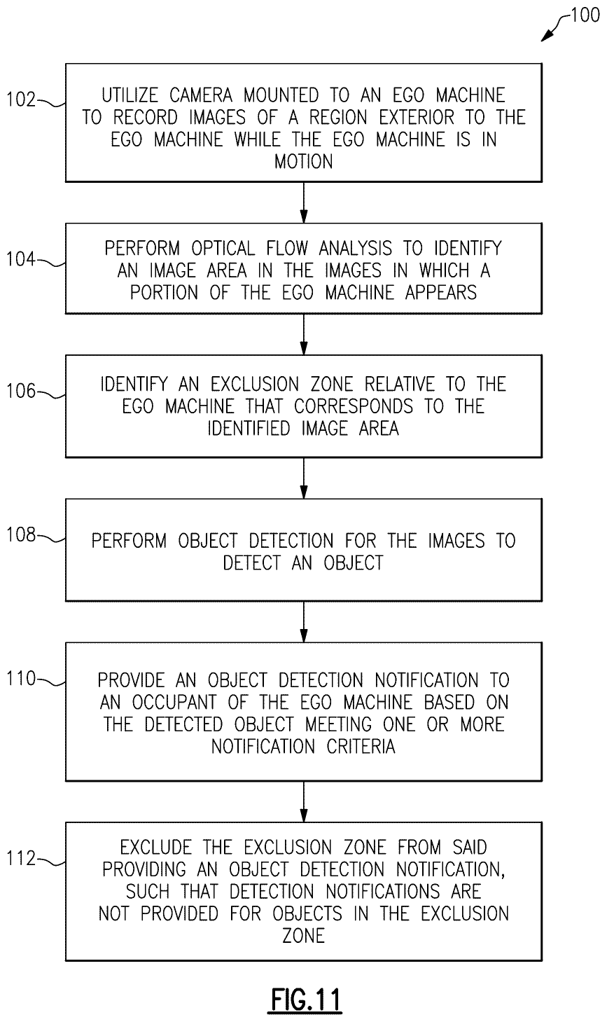

FIG. 11 is a flowchart 100 of an example method for a CMS 15 that is performed by ECU 22, and is therefore computer-implemented. Referring to FIG. 11, with continued reference to FIGS. 9-10, the CMS 15 utilizes a camera 20 while the ego machine 10 is in motion (step 102). This may include using camera 20A or 20B, with field of view FOV_{EX1} or FOV_{EX2}, for example, or may include using camera 20F or 20G, with field of view FOV_{EX5} and/or FOV_{EX6}, as another example. Thus, the region may be at least partially in front of the cabin 24 of the ego machine 10 (e.g., as in FOV_{EX6}) or may be at least partially behind the cabin 24 (e.g., as in FOV_{EX7}). In the example of FIG. 9, the depicted region is along a side of the trailer 14 of ego machine 10A. In the example of FIG. 10, the depicted region is behind the ego machine 10B.

The ECU 22 performs an optical flow analysis to identify an image area 50 in the images in which a portion 52 of the ego machine 10 appears (step 104). It is understood that the portions 52A-B shown in FIGS. 9-10 are non-limiting examples, and that other portions may be identified (e.g., corresponding to other ego machine attachments, or to portions of a commercial vehicle 10 that is not an earth moving machine).

Optical flow is a concept referring to a pattern of apparent motion of objects, surfaces, and edges in a visual scene caused by the relative motion between an observer and a scene. Optical flow can also be described as the distribution of apparent velocities of movement of a brightness pattern in an image. In one or more embodiments, the optical flow analysis in step 104 is performed using the Lucas-Kanade algorithm. Of course, it is understood that this is only an example and that other known algorithms may be used for step 104.

The ECU 22 identifies an exclusion zone 56 relative to the ego machine 10 that corresponds to the identified image area 50 (step 106). An example exclusion zone 56 corresponding to the image area 50 of FIG. 10 is shown in FIG. 5 behind the ego machine 10B. However, it is understood that the depicted exclusion zone 56 is an example, and that other exclusion zones could be used (e.g., in front of, or along one or more sides of the ego machine 10A or 10B). Also, it is understood that multiple discrete exclusion zones 56 could be used.

The ECU 22 performs object detection for the images recorded in step 102 to detect an object (step 108), and provides an object detection notification to an occupant of the ego machine 10 based on the detected object meeting one or more notification criteria (step 110). Some example notification criteria may include, e.g., the detected object being a human or an animal, or the detected object being another vehicle. Of course, these are only example criteria, and it is understood that other criteria could be used.

The ECU 22 excludes the exclusion zone 56 from the providing of the object detection notification in step 110, such that object detection notifications are not provided for objects in the exclusion zone 56 (step 112).

In one or more embodiments, the method of FIG. 11 includes excluding the exclusion zone 56 from the performing of object detection for the images in step 108, such that object detection is not performed in the exclusion zone 56. Thus, in one example the ECU 22 performs object detection for the exclusion zone 56 but just omits object detection notifications for the exclusion zone 56, and in another example the ECU 22 omits the exclusion zone 56 from the performance of object detection for some or all images from the corresponding CMS camera 20

As discussed above, the ego machine 10 may be a earth-moving machine or a commercial vehicle, for example. In one or more embodiments, the portion 52 of the ego machine 10 identified in the images is movable relative to the cabin 24 of the ego vehicle 10, and the portion 52 includes at least one of a shovel, scoop, a claw, a ripper, a roller, or a movable arm.

In one or more embodiments, the method of FIG. 11 includes storing the exclusion zone 56 in non-volatile memory to be retained for future use, and after a shut down and a subsequent startup of the ego machine 10, the exclusion zone 56 stored in non-volatile memory of the ECU 22 is used for subsequent performance of the excluding step 112 (and/or for subsequent performance of the excluding of the exclusion zone from the performance of object detection).

In one or more embodiments, the ECU 22 stores the identified image area 54 and/or the identified image area 50 for exclusion in memory so that when the ego machine 10 is turned off, the object detection area 54 and/or the identified image area 50 for exclusion are retained for future use.

The portion 52 of the ego machine 10 appears at least intermittently in the images recorded in step 102. The portion 52 of the ego machine 10 may always, or just occasionally, appear in the image area 50 of the images. To elaborate, the image area 50 may be static relative to a cabin of the ego machine 10 (and thereby continuously appear in the identified image area 50 in images from a corresponding CMS camera 20 that records the images), or the portion 52 of the ego machine 10 may be movable relative to the cabin 24 of the ego machine 10, such that the portion 52 may sometimes not appear in the identified image area 50, but is static relative to the cabin 24 for multiple image frames.

Use of an optical flow analysis to identify the image area 50 is advantageous because portion 52 of the ego machine 10 will likely, if not at all times, at least during multiple image frames recorded while the ego machine 10 is moving.

In one or more embodiments, the exclusion zone 56 is a two-dimensional area of the images recorded by one or more of the CMS cameras 20 (e.g., just area 50A-B of FIGS. 9-10).

In one or more embodiments, the exclusion zone 56 is a three-dimensional space, and the exclusion extends beyond the cameras 20 to the object detection sensors 26. In one or more such embodiments, objects detected by one or more of the object detection sensors 26 are excluded from the notification step 110 and/or the object detection step 108 if those objects reside in the three-dimensional exclusion zone 56 (e.g., even if the object(s) are only detected by the object detection sensor(s) 26 and are not detected by the camera(s) 20). Although object detection sensors 26 are only depicted for ego vehicle 10B, it is understood that they could also be included for ego vehicle 10A.

Although example embodiments have been disclosed, a worker of ordinary skill in this art would recognize that certain modifications would come within the scope of the claims. For that reason, the following claims should be studied to determine their true scope and content.

What is claimed is:

1. A method for a camera monitor system (CMS), comprising:
utilizing a camera mounted to an ego machine to record images of a region exterior to the ego machine while the ego machine is in motion;
performing an optical flow analysis to identify an image area in the images in which a portion of the ego machine appears;
identifying an exclusion zone relative to the ego machine that corresponds to the identified image area;
performing object detection for the images to detect an object;
providing an object detection notification to an occupant of the ego machine based on the detected object meeting one or more notification criteria; and
excluding the exclusion zone from said providing an object detection notification, such that object detection notifications are not provided for objects in the exclusion zone.

2. The method of claim 1, comprising:
excluding the exclusion zone from said performing object detection for the images, such that object detection is not performed in the exclusion zone.

3. The method of claim 1, wherein said performing an optical flow analysis comprises using a Lucas-Kanade algorithm.

4. The method of claim 1, wherein the exclusion zone is a two-dimensional area of the images.

5. The method of claim 1, wherein the exclusion zone is a three-dimensional space depicted in the images.

6. The method of claim 1, wherein the region is at least partially in front of a cabin of the ego machine.

7. The method of claim 1, wherein the region is at least partially behind a cabin of the ego machine.

8. The method of claim 1, wherein the ego machine is an earth-moving machine.

9. The method of claim 8, wherein:
the portion of the ego machine is movable relative to a cabin of the ego machine; and
the portion of the ego machine includes at least one of a shovel, scoop, a claw, a ripper, a roller, or a movable arm.

10. The method of claim 1, wherein the method comprises:
storing the exclusion zone in non-volatile memory; and
after a shut down and subsequent startup of the ego machine, utilizing the exclusion zone stored in the non-volatile memory for the excluding step.

11. A camera monitor system (CMS), comprising:
a camera mounted to an ego machine, the camera configured to obtain images of a region exterior to the ego machine; and
processing circuitry operatively connected to memory and configured to:
utilize a camera mounted to an ego machine to record images of a region exterior to the ego machine while the ego machine is in motion;
perform an optical flow analysis to identify an image area in the images in which a portion of the ego machine appears;
identify an exclusion zone relative to the ego machine that corresponds to the identified image area;
perform object detection for the images to detect an object;
provide an object detection notification to an occupant of the ego machine based on the detected object meeting one or more notification criteria; and
exclude the exclusion zone from the providing of the object detection notification, such that object detection notifications are not provided for objects in the exclusion zone.

12. The CMS of claim 11, wherein the processing circuitry is configured to exclude the exclusion zone from the performance of object detection for the images, such that object detection is not performed in the exclusion zone.

13. The CMS of claim 11, wherein the processing circuitry is configured to use a Lucas-Kanada algorithm to perform the optical flow analysis.

14. The CMS of claim 11, wherein the exclusion zone is a two-dimensional area of the images.

15. The CMS of claim 11, wherein the exclusion zone is a three-dimensional space depicted in the images.

16. The CMS of claim 11, wherein the region is at least partially in front of a cabin of the ego machine.

17. The CMS of claim 11, wherein the region is at least partially behind a cabin of the ego machine.

18. The CMS of claim 11, wherein the ego machine is an earth-moving machine.

19. The CMS of claim 18, wherein:
the portion of the ego machine is movable relative to a cabin of the ego machine; and
the portion of the ego machine includes at least one of a shovel, scoop, a claw, a ripper, a roller, or a movable arm.

20. The CMS of claim 11,
wherein the memory includes non-volatile memory; and
the processing circuitry is configured to:
store the exclusion zone in non-volatile memory; and
after a shut down and subsequent startup of the ego machine, utilize the exclusion zone stored in the non-volatile memory for performance of the excluding of the exclusion zone.
